(19) United States
(12) Patent Application Publication
(10) Pub. No.: US 2026/0178243 A1
(43) Pub. Date: Jun. 25, 2026

(54) SERVER, REPORT OUTPUT METHOD, AND REPORT OUTPUT SYSTEM

(71) Applicant: SEIKO EPSON CORPORATION, Tokyo (JP)

(72) Inventor: Yoshio OKUMURA, MATSUMOTO-SHI (JP)

(21) Appl. No.: 19/431,217

(22) Filed: Dec. 23, 2025

(30) Foreign Application Priority Data
Dec. 24, 2024 (JP) 2024-227529

(51) Int. Cl. G06F 3/12

(52) U.S. Cl. CPC G06F 3/1208; G06F 3/1229; G06F 3/1256

(57) ABSTRACT

A communication unit of a server receives color material value information indicating a color material value of each of patches and a chart image from a reception target device via a network, and transmits report information related to a printer to a transmission target device via the network. A processing unit of the server determines, based on the color material value information and the chart image, an appropriate range of the color material value of each of the patches and the recommended value, and generates reliability information indicating reliability of the recommended value. The processing unit includes, in an overall image display part, appropriate range information that distinguishes a plurality of appropriate range patches among the plurality of patches that are within the appropriate range from a remaining plurality of inappropriate range patches in an overall image of the chart. The processing unit adds, in a recommended portion display part, the reliability information to a recommended patch corresponding to the recommended value.

The present application is based on, and claims priority from JP Application Serial Number 2024-227529, filed Dec. 24, 2024, the disclosure of which is hereby incorporated by reference herein in its entirety.

### BACKGROUND

### 1. Technical Field

The present disclosure relates to a server capable of communicating information for a printer capable of printing a chart including a plurality of patches, a report output method, and a report output system.

### 2. Related Art

As a printing device, an inkjet printer that dispenses ink droplets from a printing head to a printing medium is known. When a dispensing amount of an ink per unit area with respect to the printing medium is large, for example, a bleeding phenomenon in which the ink bleeds out to a periphery occurs, and a color saturation state in which color development hardly changes even when the ink dispensing amount increases is obtained. Therefore, a chart including a plurality of patches for selecting a maximum ink amount, which is an upper limit of the ink amount per unit area on the printing medium, is printed on the printing medium, and the maximum ink amount is set based on a selection result of the patches. The set maximum ink amount is used for creating a color conversion LUT (lookup table) or the like.

As disclosed in JP-A-2021-192190, a print system including a cloud print service and a printing device is also known.

JP-A-2021-192190 is an example of the related art.

In order to determine the maximum ink amount, it is conceivable to obtain an inference result of the optimum maximum ink amount from a server having a trained model generated by machine learning. However, even when the user cannot satisfy the maximum ink amount that is the inference result by the trained model, the color conversion LUT is generated according to the inference result. Therefore, a new mechanism for the user to determine the maximum ink amount is desired.

### SUMMARY

A server according to the present disclosure is a server for communicating, via a network, information for a printer configured to print a chart including a plurality of patches, the server includes:
a communication unit configured to receive, from a reception target device via the network, color material value information indicating a color material value of each of the patches and a chart image obtained by reading the chart, and to transmit report information related to the printer to a transmission target device via the network; and
a processing unit configured to generate the report information including an overall image display part indicating an overall image of the chart including the plurality of patches, and a recommended portion display part indicating a recommended patch corresponding to a recommended value of the color material value among the plurality of patches,
the processing unit
   determines, based on the color material value information and the chart image, an appropriate range of the color material value and the recommended value of each of the patches, and generates reliability information indicating reliability of the recommended value,
   includes, in the overall image display part, appropriate range information that distinguishes a plurality of appropriate range patches among the plurality of patches that are within the appropriate range from a remaining plurality of inappropriate range patches in an overall image of the chart, and
   adds, in the recommended portion display part, the reliability information to the recommended patch.

A report output method according to the present disclosure in which information for a printer configured to print a chart including a plurality of patches is output by a server configured to communicate via a network, the method includes:
a reception step of receiving, from a reception target device via the network, color material value information indicating a color material value of each of the patches and a chart image obtained by reading the chart;
a prediction step of determining, based on the color material value information and the chart image, an appropriate range and a recommended value of the color material value of each of the patches, and generating reliability information indicating reliability of the recommended value; and
an overall image processing step of including, in an overall image display part included in report information related to the printer, appropriate range information that distinguishes a plurality of appropriate range patches among the plurality of patches that are within the appropriate range from a remaining plurality of inappropriate range patches in an overall image of the chart including the plurality of patches;
a recommended portion processing step of adding, in a recommended portion display part included in the report information, the reliability information to a recommended patch corresponding to the recommended value among the plurality of patches; and
a transmission step of transmitting the report information including the overall image display part and the recommended portion display part to a transmission target device via the network.

Further, a report output system according to the present disclosure is a report output system including:
a server configured to communicate, via a network, information for a printer configured to print a chart including a plurality of patches; and
a transmission target device coupled to the network,
the server includes
   a communication unit configured to receive, from a reception target device via the network, color material value information indicating a color material value of each of the patches and a chart image obtained by reading the chart, and to transmit report information related to the printer to a transmission target device via the network, and
   a processing unit configured to generate the report information including an overall image display part indicating an overall image of the chart including the plurality of patches, and a recommended portion display part indicating a recommended patch corresponding to a recommended value of the color material value among the plurality of patches,
the processing unit
   determines, based on the color material value information and the chart image, an appropriate range of the color material value and the recommended value of each of the patches, and
   generates reliability information indicating reliability of the recommended value,
   includes, in the overall image display part, appropriate range information that distinguishes a plurality of appropriate range patches among the plurality of patches that are within the appropriate range from a remaining plurality of inappropriate range patches in an overall image of the chart,
   adds, in the recommended portion display part, the reliability information to the recommended patch, and
the transmission target device receives the report information from the server via the network and prints or displays the received report information.

### BRIEF DESCRIPTION OF THE DRAWINGS

FIG. 1 is a block diagram schematically showing a configuration example of a cloud print system.

FIG. 2 is a block diagram schematically showing a configuration example of a server and a printer included in the cloud print system.

FIG. 3 is a diagram schematically showing an example of a chart on a printing medium.

FIG. 4 is a diagram schematically showing an example of a training chart image and a test chart image.

FIG. 5 is a diagram schematically showing an example of generating a data set from a plurality of training images having different ink amounts per unit area.

FIG. 6 is a diagram schematically showing an example of a trained model generated by a trained model generation device and used by a support device.

FIG. 7 is a diagram schematically showing an example of prediction information indicating whether the ink amount per unit area of each test image is within an appropriate range of a maximum ink amount or out of the appropriate range.

FIG. 8 is a diagram schematically showing a display example of report information including an overall image display part and a recommended portion display part.

FIG. 9 is a flowchart schematically showing an example of trained model generation processing.

FIG. 10 is a flowchart schematically showing an example of report output processing.

FIG. 11 is a flowchart schematically showing an example of maximum ink amount prediction processing.

FIG. 12 is a diagram schematically showing an example of generating reliability information.

FIG. 13 is a diagram schematically showing another example of generating the reliability information.

FIG. 14 is a diagram schematically showing an example of a structure of a color conversion lookup table.

### DESCRIPTION OF EMBODIMENTS

An embodiment of the present disclosure will be described below. The following embodiment, of course, merely shows an example of the present disclosure, and all the features shown in the embodiment are not necessarily essential to the solution disclosed herein.

### 1. Overview of Aspects Included in Present Disclosure

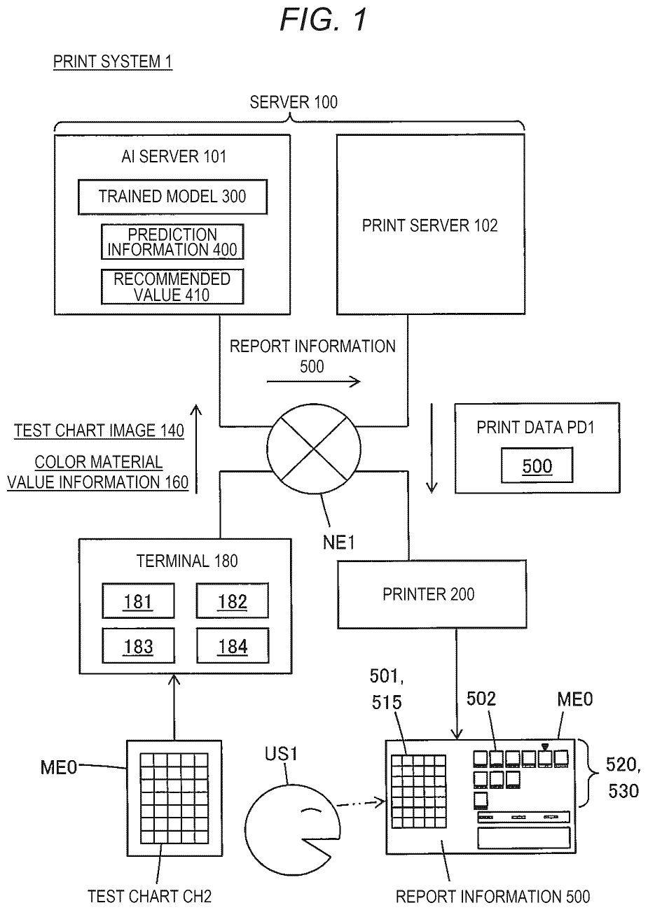

An overview of aspects included in the present disclosure will first be described with reference to examples shown in FIGS. 1 to 14. The drawings in the present application schematically show examples, and that the magnification in each direction shown in the drawings may vary and the drawings may not be consistent with each other. Obviously, each element in the present aspects is not limited to a specific example denoted by the reference symbol. In “Overview of aspects included in present disclosure”, a term in parentheses means a supplementary description of the term immediately before the parentheses.

In the present application, a numerical range “Min to Max” means numerals equal to or greater than a minimum value Min but equal to or smaller than a maximum value Max.

### Aspect 1

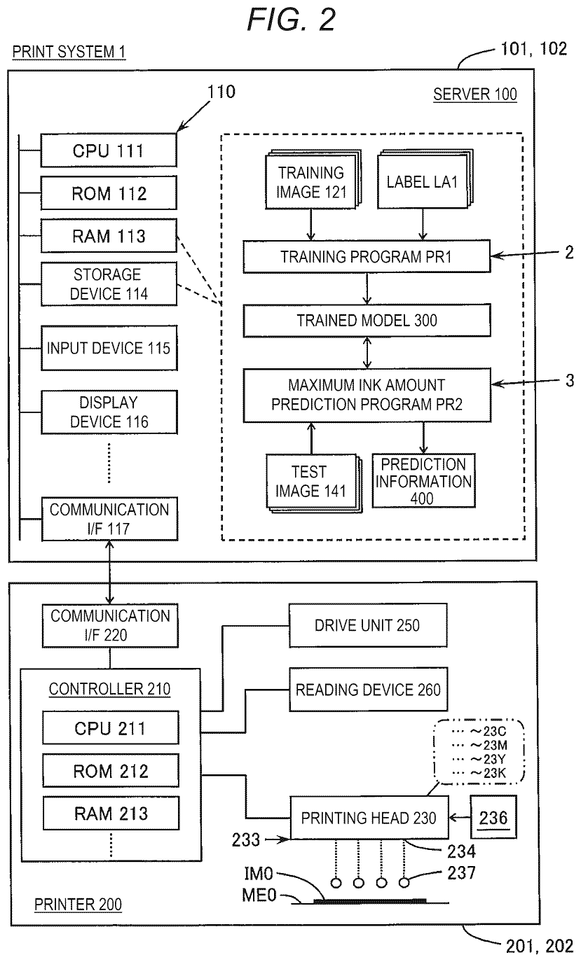

As shown in FIGS. 1 and 2, a server 100 according to an aspect is a server 100 capable of communicating information for a printer 200 capable of printing a chart (for example, a test chart CH2) including a plurality of patches (for example, a test patch PA2) via a network, and includes a communication unit (for example, a communication I/F 117) and a processing unit 110. The communication unit (117) receives color material value information 160 indicating a color material value of each of the patch (PA2) and a chart image (for example, a test chart image 140) obtained by reading the chart (CH2) from a reception target device via the network, and transmits report information 500 regarding the printer 200 to a transmission target device via the network. The processing unit 110 generates the report information 500 including an overall image display part 501 indicating an overall image of the chart (CH2) including the plurality of patches (PA2) and a recommended portion display part 502 indicating a recommended patch 520 corresponding to a recommended value 410 of the color material value among the plurality of patches (PA2). The processing unit 110 determines, based on the color material value information 160 and the chart image (140), an appropriate range of the color material value of each of the patches (PA2) and the recommended value 410, and generates reliability information 530 indicating reliability of the recommended value 410. In the overall image display part 501, the processing unit 110 includes, in the overall image of the chart (CH2), appropriate range information 515 for distinguishing a plurality of appropriate range patches 511 in the appropriate range among the plurality of patches (PA2) from a plurality of remaining inappropriate range patches 512. In the recommended portion display part 502, the processing unit 110 adds the reliability information 530 to the recommended patch 520.

When the user views the report information 500, the user can check the plurality of appropriate range patches 511 in the appropriate range of the color material value from the overall image of the chart (CH2) in the overall image display part 501, and can check the recommended patch 520 corresponding to the recommended value 410 of the color material value in the recommended portion display part 502. Here, since the reliability information 530 indicating the reliability of the recommended value 410 is added to the recommended patch 520, a user can select the recommended patch 520 or the patch (PA2) other than the recommended patch 520 with reference to the reliability information 530. For example, the user can select the recommended patch 520 when the reliability of the recommended value 410 is high, or select the appropriate range patch 511 other than the recommended patch 520 when the reliability of the recommended value 410 is low. Therefore, the above aspect can provide a server capable of obtaining, via a network, report information in which a patch can be selected in consideration of a desire of the user.

Various examples are listed in the aspect described above.

The chart may be a chart for determining a maximum ink amount, which is the upper limit of an ink amount per unit area on the printing medium, a color selection chart for adjusting a printing color, or the like.

The color material value of the patch includes a value corresponding to an amount of ink to be used for printing the patch. The ink is generally a liquid containing a colorant such as a pigment or a dye, and may be a powdery solid such as a toner ink.

The color material value information may include a type of ink to be used for printing the patch.

The chart may be read by a scanner or may be read by a camera or the like. Therefore, the chart image may be an image read by a scanner, an image captured by a camera, or the like.

The reception target device may be a printer, a terminal other than a printer, or the like. The transmission target device may be a printer, a terminal other than a printer, or the like.

An appropriate range of the color material value means a range predicted to be appropriate with a width as the color material value. The recommended value of the color material value means a value predicted to be optimal as the color material value, and is included in the above-described appropriate range.

The appropriate range information includes various examples. The processing unit may include, in the overall image of the chart, appropriate range information for making a plurality of appropriate range patches conspicuous by thinning the plurality of inappropriate range patches. The processing unit may include appropriate range information for distinguishing the plurality of inappropriate range patches from each other by surrounding the plurality of appropriate range patches with a line or the like in the overall image of the chart.

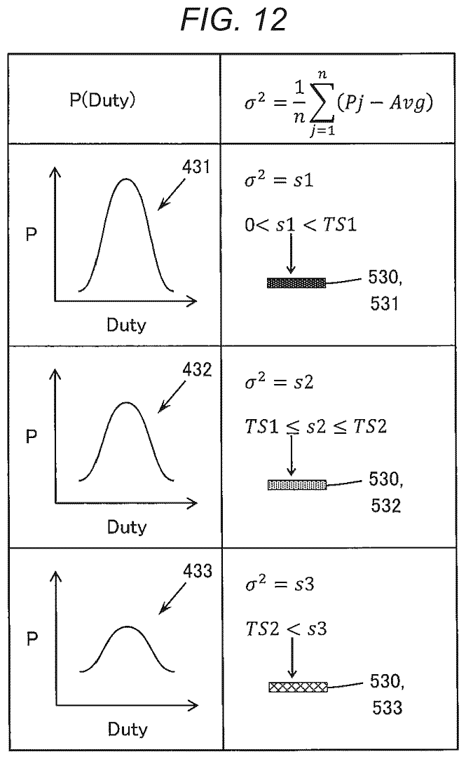

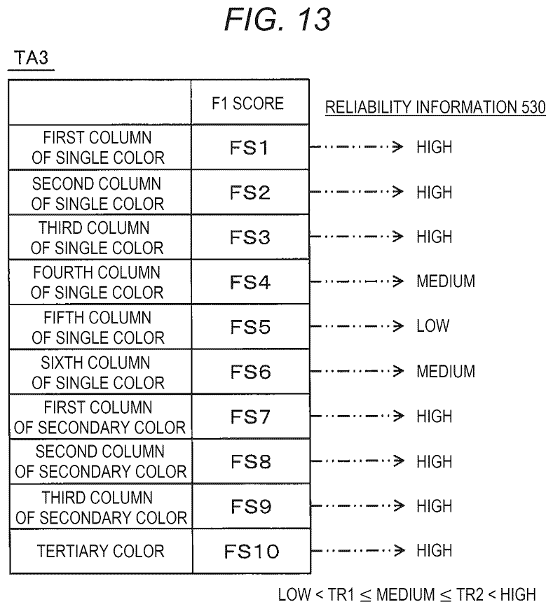

The reliability information may be information obtained by performing statistical processing on an index corresponding to the ink amount per unit area (for example, an appropriateness index P(Duty)), such as a variance σ² shown in FIG. 12, or may be information based on an index indicating performance of a trained model, such as a F1 score shown in FIG. 13. The reliability information may indicate the reliability of the recommended value in a stepwise manner by color coding, a pattern, or the like, or may continuously indicate the reliability of the recommended value by a numerical value, a graph, or the like.

The server is also referred to as a server computer. The server may include one computer or two or more computers.

Obviously, the additional remarks described above also apply to the following aspects.

### Aspect 2

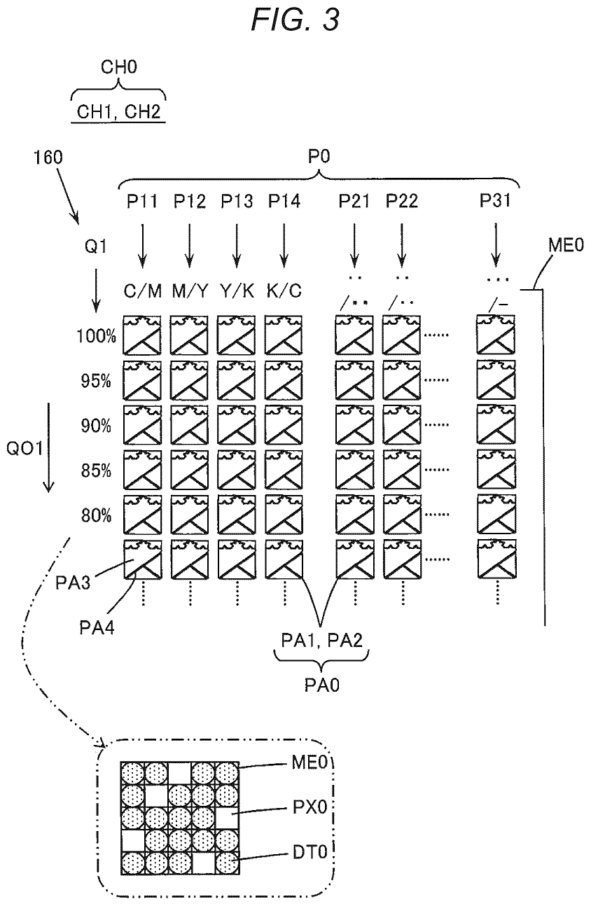

As shown in FIG. 3, the chart (CH2) may include the plurality of patches (PA2) having different ink amounts Q1 per unit area on a printing medium ME0. The color material value of each of the patches (PA2) may correspond to the ink amount Q1 per unit area of the patch (PA2). The appropriate range and the recommended value 410 may be applied to a maximum ink amount Qm which is an upper limit of the ink amount Q1 per unit area. The processing unit 110 may determine, based on the color material value information 160 and the chart image (140), the appropriate range and the recommended value 410 for the maximum ink amount Qm.

In this case, report information capable of determining the maximum ink amount in consideration of a desire of the user can be obtained from the server.

Here, the patch for checking the maximum ink amount may include a pattern such as a linear image, or may be a solid patch having a uniform recording density. To describe with reference to FIGS. 2 and 3, the recording density (referred to as RD) means a ratio (including a percentage) of the number of dots DT0 formed by ink droplets 237 with respect to a predetermined number of pixels PX0 on the printing medium ME0, and means a ratio when converted to a largest dot (for example, a large dot) when dots having different sizes are formed. A pixel PX0 is a minimum element constituting an image and can be assigned a color independently. Although 25 pixels PX0 are shown in FIG. 3, when Nd large dots are formed with respect to 100 pixels PX0, the recording density RD is Nd %. The ink amount Q1 per unit area means the amount of ink dispensed from the printing head 230 to a unit area of the printing medium ME0, corresponds to the ink amount for forming a patch PA0 of the recording density RD on the printing medium ME0, and is substantially equal to the recording density RD.

The above-described additional features are also applied to the following aspects.

### Aspect 3

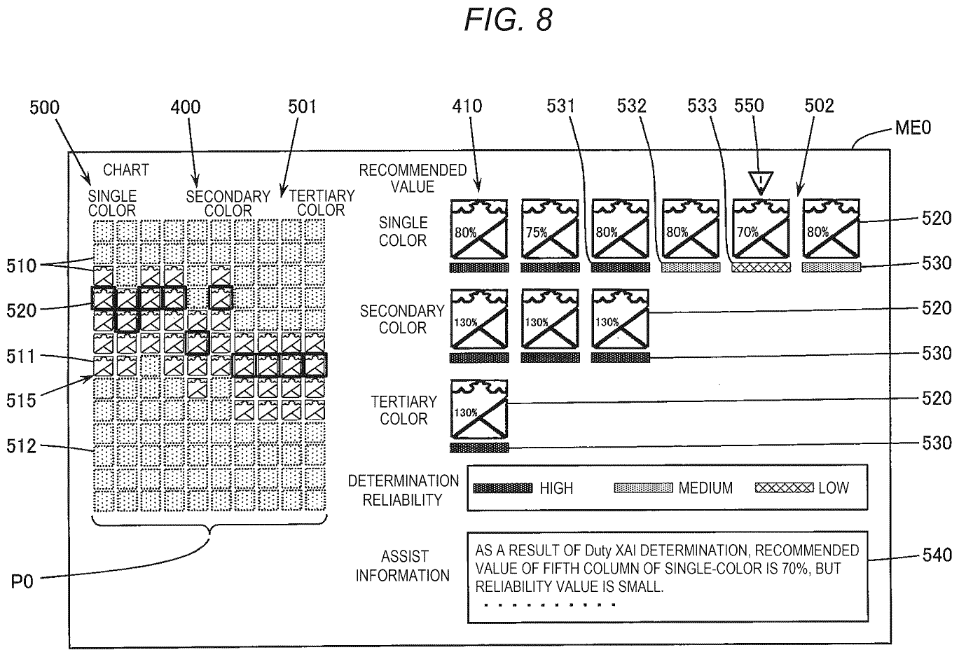

As shown in FIGS. 8, 10, and 11, the processing unit 110 may generate consideration information 540 representing consideration for determination of the recommended value 410 based on the color material value information 160 and the chart image (140), and may generate the report information 500 further including the consideration information 540.

In this case, the user can select the patch (PA2) from the chart (CH2) with reference to the consideration for the determination of the recommended value 410 by the server 100. Therefore, in the above aspect, it is possible to obtain report information suitable for patch selection from the server.

### Aspect 4

As shown in FIG. 1, the reception target device may be a terminal 180. The transmission target device may be the printer 200. The processing unit 110 may generate the report information 500 to be printed by the printer 200.

In this case, since the report information 500 including the recommended patch 520 is printed on the printing medium ME0 by the printer 200, the user can check printing quality corresponding to the recommended value 410 in the report information 500. Therefore, in the above aspect, it is possible to obtain report information suitable for patch selection from the server.

### Aspect 5

The processing unit 110 may generate the report information 500 (see FIG. 8) such that the recommended patch 520 is equal to or larger than the size of the patch (PA2) in the chart (CH2).

In this case, since the recommended patch 520 corresponding to the recommended value 410 is printed with a size equal to or larger than the size of the patch (PA2) in the chart (CH2), the user can check the printing quality corresponding to the recommended value 410 in the report information 500. Therefore, in the above aspect, it is possible to obtain report information suitable for patch selection from the server.

### Aspect 6

As shown in FIG. 8, the processing unit 110 may include, in the overall image of the chart (CH2), the appropriate range information 515 obtained by thinning or hiding the plurality of inappropriate range patches 512 in the overall image display part 501.

In the overall image display part 501, when the plurality of inappropriate range patches 512 are thin or hidden, the plurality of appropriate range patches 511 are conspicuous. Accordingly, the user can easily check the patch (PA2) in the appropriate range among the plurality of patches (PA2). Therefore, in the above aspect, it is possible to obtain report information suitable for patch selection from the server.

### Aspect 7

As shown in FIGS. 8, 10, and 12 and the like, when the reliability information 530 is lower than a predetermined reference, the processing unit 110 may control the communication unit (117) to transmit warning information 550 indicating that the reliability information 530 is lower than the reference to the transmission target device. Examples of a case in which the reliability information 530 is smaller than the predetermined reference include a case in which a standard deviation σ² shown in FIG. 12 is greater than a predetermined threshold TS2, a case in which the F1 score shown in FIG. 13 is smaller than a predetermined threshold TR1, and the like.

In this case, the user can grasp that the reliability of the recommended value 410 is low according to the warning information 550. Therefore, in the above aspect, it is possible to obtain report information suitable for patch selection from the server.

Here, the warning information may be information to be printed by the printer, information to be displayed on the transmission target device, or information to be output by the transmission target device.

### Aspect 8

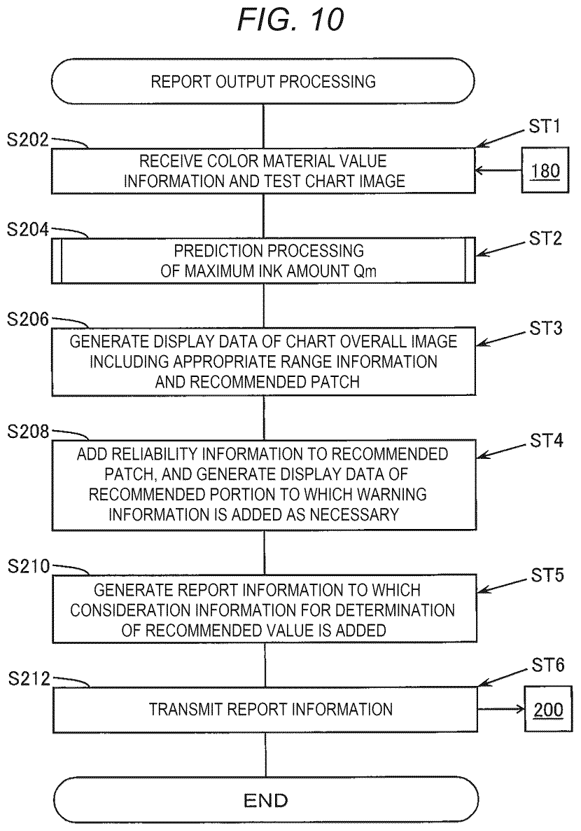

A report output method according to an aspect is a report output method performed by the server 100 capable of communicating information for the printer 200 capable of printing the chart (CH2) including the plurality of patches (PA2) via the network. As shown in FIG. 10, the report output method includes the following steps.

(a1) A reception step ST1 of receiving, from a reception target device via a network, the color material value information 160 indicating a color material value of each of patches (PA2) and a chart image (140) obtained by reading a chart (CH2).

(a2) A prediction step ST2 of determining, based on the color material value information 160 and the chart image (140), an appropriate range and the recommended value 410 of the color material value of each of the patches (PA2), and generating the reliability information 530 indicating reliability of the recommended value 410.

(a3) In the overall image display part 501 included in the report information 500 related to the printer 200, an overall image processing step ST3 including the appropriate range information 515 in the overall image of the chart (CH2) including the plurality of patches (PA2), which distinguishes the plurality of appropriate range patches 511 that are within the appropriate range among the plurality of patches (PA2) from the remaining plurality of inappropriate range patches 512.

(a4) In the recommended portion display part 502 included in the report information 500, a recommended portion processing step ST4 of adding the reliability information 530 to the recommended patch 520 corresponding to the recommended value 410 among the plurality of patches (PA2).

(a5) A transmission step ST6 of transmitting the report information 500 including the overall image display part 501 and the recommended portion display part 502 to a transmission target device via the network.

The above aspect can provide a report output method capable of obtaining, from a server, report information in which a patch can be selected in consideration of a desire of the user.

Further, the above-described aspect can be applied to a report output system including the above-described server and one or more transmission target devices, a print system including the above-described server and one or more printers, a print system including the above-described server, one or more terminals, and one or more printers, a report printing method including a report output method, a report generation program for generating report information, a non-transitory computer-readable medium in which the report generation program is recorded, and the like.

### 2. Configuration Example of Print System Including Trained Model Generation Device and Support Device

FIG. 1 schematically shows a configuration of a cloud print system that provides the report information 500 for the printer 200 to a user US1 via a network NE1.

The print system 1 shown in FIG. 1 includes an artificial intelligence (AI) server 101, a print server 102, one or more terminals 180, and one or more printers 200. These elements (101, 102, 180, and 200) are coupled to the network NE1. The network NE1 may be the Internet to which a large number of communication devices in the world are connected according to common communication specifications, may be a wide area network in a limited range, or may be a local area network (LAN) or the like. The AI server 101 is an AI server that can be described, and thus can also be referred to as an XAI server. A combination of the AI server 101 and the print server 102 is an example of the server 100. Obviously, the AI server 101 may be two or more computers, the print server 102 may be two or more computers, and the server 100 may be one computer.

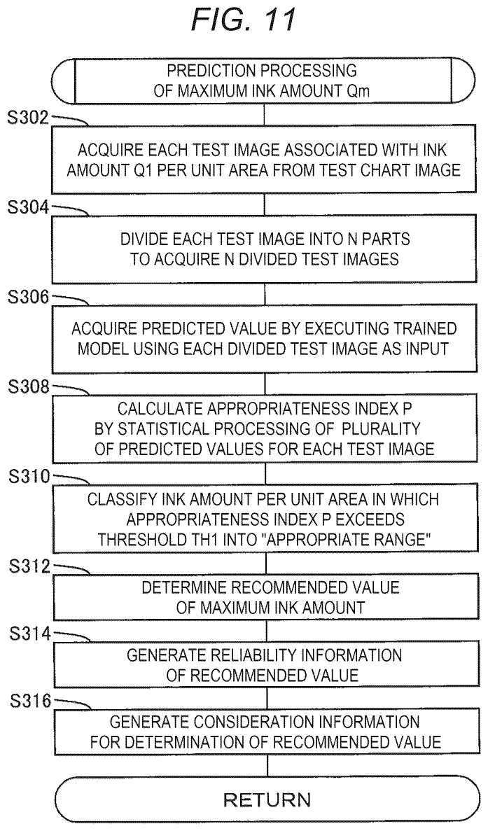

The user US1 shown in FIG. 1 can obtain the report information 500 regarding the printer 200 by causing the printer 200 to form the printing medium ME0 having the test chart CH2 including the plurality of test patches PA2 and causing the terminal 180 to read the test chart CH2. The terminal 180 transmits the color material value information 160 indicating the ink amount Q1 (see FIG. 3) per unit area of each test patch PA2 in the printing medium ME0 and the test chart image 140 obtained by reading the test chart CH2 to the AI server 101 via the network NE1. The AI server 101 receives the color material value information 160 and the test chart image 140 from the terminal 180 via the network NE1, generates the report information 500 based on the color material value information 160 and the test chart image 140, and transmits the report information 500 to the print server 102. The terminal 180 is an example of a reception target device. The AI server 101 stores a trained model 300 for outputting prediction information 400 of the appropriate range, the recommended value 410 of the maximum ink amount Qm, and the like for the maximum ink amount Qm (see FIG. 11) which is the upper limit of the ink amount Q1 per unit area in the printing medium ME0. The report information 500 includes the overall image display part 501 indicating the overall image of the test chart CH2 including the appropriate range information 515 determined from the prediction information 400, the recommended portion display part 502 in which the reliability information 530 is added to the recommended patch 520 corresponding to the recommended value 410, and the like. The reliability information 530 indicates the reliability of the recommended value 410. The print server 102 receives the report information 500 from the AI server 101, generates print data PD1 including the report information 500 to be printed by the printer 200, and transmits the print data PD1 to the printer 200 via the network NE1. The printer 200 is an example of the transmission target device. The printer 200 receives the print data PD1 from the print server 102 via the network NE1 and prints the report information 500 on the printing medium ME0.

When the user US1 views the report information 500, the user US1 can check the appropriate range of the maximum ink amount Qm from the overall image of the test chart CH2 in the overall image display part 501, and can check the recommended patch 520 corresponding to the recommended value 410 in the recommended portion display part 502. Since the reliability information 530 is added to the recommended patch 520, the user US1 can select the recommended patch 520 or the test patch PA2 other than the recommended patch 520 with reference to the reliability information 530.

The terminal 180 includes a central processing unit 181 (CPU), a read only memory 182 (ROM), a random access memory 183 (RAM), a reading device 184, a storage device, an input device, a display device, a communication interface (I/F) connected to the network NE1, and the like. Examples of the terminal 180 include a personal computer including a tablet terminal, a mobile phone including a smartphone, and a digital camera including a digital video camera. Examples of the reading device 184 include a camera capable of capturing an image of a chart including the test chart CH2, and a scanner capable of reading a chart including the test chart CH2. The reading device 184 may be an external device coupled to a main body of the terminal 180.

FIG. 2 schematically shows configurations of the server 100 and the printer 200 included in the print system 1. The server 100 shown in FIG. 2 includes the AI server 101 including the trained model generation device 2 and a part of the support device 3, and the print server 102 including a part of the support device 3. The trained model generation device 2 and the support device 3 are devices for supporting the determination of the maximum ink amount Qm. Since the AI server 101 and the print server 102 have hardware configurations similar to each other, the hardware configurations will be collectively described as the hardware configuration of the server 100. The printer 200 shown in FIG. 2 collectively refers to a reference printer 201 to be used to generate the trained model 300 and a client printer 202 that outputs the report information 500 to the user US1. Since the reference printer 201 and the client printer 202 have similar hardware configurations, the hardware configurations will be collectively described as the hardware configuration of the printer 200. FIG. 3 schematically shows a chart CH0 on the printing medium ME0. FIG. 3 collectively shows a trained chart CH1 and the test chart CH2 as the chart CH0. In FIG. 3, a schematic diagram showing an example of the ink amount Q1 per unit area is shown in a region surrounded by a two-dot chain line. The ink amount Q1 per unit area of the patch PA0 corresponds to a color material value of the patch PA0. The printer 200 can form a print image IM0 including the chart CH0.

The server 100 includes a CPU 111, a ROM 112, a RAM 113, a storage device 114, an input device 115, a display device 116, the communication I/F 117, and the like. The elements (111 to 117) described above are electrically coupled to each other and can input and output information to and from each other. The ROM 112, the RAM 113, and the storage device 114 are memories, and at least the ROM 112 and the RAM 113 are semiconductor memories. The server 100 includes the processing unit 110 mainly formed of the CPU 111. The RAM 113 is an example of a holding unit. The input device 115 is an example of an operation unit. The display device 116 is an example of a display unit. The communication I/F 117 is an example of a communication unit.

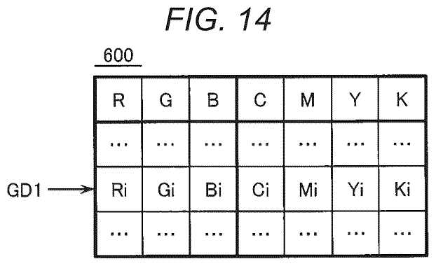

The storage device 114 of the AI server 101 stores an operating system (OS) (not shown), a training program PR1, a maximum ink amount prediction program PR2, and the like. The training program PR1 causes the AI server 101, which is a computer, to function as the trained model generation device 2. In order to execute the training program PR1, a plurality of training images 121 included in the trained chart CH1 shown in FIG. 3 and a plurality of labels LA1 respectively associated with the plurality of training images 121 are stored in the RAM 113. After the training program PR1 is executed, the trained model 300 is stored in the storage device 114. The maximum ink amount prediction program PR2 causes the AI server 101 to function as the support device 3. In order to execute the maximum ink amount prediction program PR2, a plurality of test images 141 included in the test chart CH2 shown in FIG. 3 are stored in the RAM 113. After the maximum ink amount prediction program PR2 is executed, the prediction information 400 is stored in the RAM 113. Since both the RAM 113 and the storage device 114 are memories, the storage device 114 may function as an information holding unit, or the RAM 113 may hold the trained model 300. The storage device 114 of the print server 102 stores a color conversion LUT (lookup table) 600 shown in FIG. 14. In the color conversion LUT 600 shown in FIG. 14, a correspondence relationship between coordinate values of R (red), G (green), and B (blue) and coordinate values of C (cyan), M (magenta), Y (yellow), and K (black) is defined for a plurality of grid points GD1. A variable i shown in FIG. 14 is a variable for identifying each of the grid points GD1.

Examples of the storage device 114 may include a nonvolatile semiconductor memory such as a flash memory, and a magnetic storage device such as a hard disk.

Examples of the input device 115 include a pointing device, hardware keys such as a keyboard, and a touch panel attached to a surface of a display panel. The input device 115 may be an external device coupled to a main body of the server 100. Examples of the display device 116 include a liquid crystal display and an organic EL display. The display device 116 may be an external device coupled to the main body of the server 100. The communication I/F 117 is coupled to the network NE1 and inputs and outputs information to and from the terminal 180 and the printer 200. For example, the communication I/F 117 of the AI server 101 receives the color material value information 160 and the test chart image 140 from the terminal 180 via the network NE1. The communication I/F 117 of the print server 102 transmits the report information 500 to the printer 200 via the network NE1.

The CPU 111 reads information stored in the storage device 114 as appropriate into the RAM 113 and executes the read programs to perform various kinds of processing. The CPU 111 of the AI server 101 executes the training program PR1 read by the RAM 113 to perform processing corresponding to the function of the trained model generation device 2. In addition, the CPU 111 of the AI server 101 performs the processing corresponding to the function of the support device 3 by executing the maximum ink amount prediction program PR2 read in the RAM 113. The CPU 111 of the print server 102 executes a print control program (not shown) to perform color conversion processing, halftone processing, print data generation processing, print data transmission processing, and the like. For example, as the color conversion processing, the CPU 111 performs processing of converting RGB data having an integer value equal to or greater than 2⁸ gradations of R, G, and B in each pixel into ink amount data according to a color conversion LUT 600 of FIG. 14. The ink amount data has, for example, an integer value equal to or greater than 2⁸ gradations of C, M, Y, and K in each pixel. The CPU 111 performs, as the halftone processing, processing of generating dot data in which the number of gradations is reduced by performing the halftone processing on the ink amount data. The CPU 111 performs processing of generating the print data PD1 by adding command data to the dot data as print data generation processing. The computer-readable non-transitory recording medium storing the programs (PR1, PR2, and the like) is not limited to the storage device inside the server 100, and may be a recording medium outside the server 100.

The number of the CPUs 111 of the processing unit 110 may be one or two or more. In addition, a part or all of the processing unit 110 can be replaced with hardware such as a digital signal processor (DSP), an application specific integrated circuit (ASIC), a programmable logic device (PLD), and a field programmable gate array (FPGA). The trained model generation device 2 and the support device 3 may be implemented by separate computers.

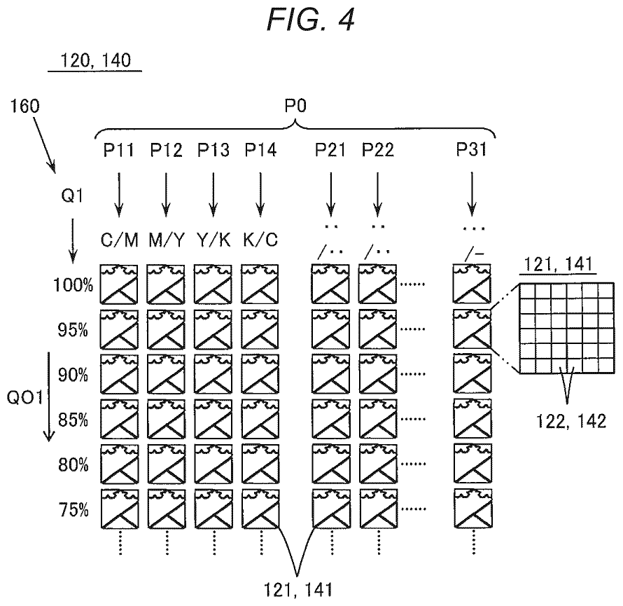

The printer 200 shown in FIG. 2 is an inkjet printer that ejects a C (cyan) ink, a M (magenta) ink, a Y (yellow) ink, and a K (black) ink as an ink 236 containing a color material from the printing head 230 onto the printing medium ME0. Therefore, the ink 236 shown in FIG. 2 has four types of different colors. The printer 200 includes a controller 210, a communication I/F 220, a printing head 230, a drive unit 250, and the like. The printer 200 may include a reading device 260 capable of reading the chart CH0 on the printing medium ME0. The chart image (see FIG. 4) including the training chart image 120 and the test chart image 140 may be generated by the reading device 260 reading the chart CH0. Examples of the reading device 260 include a scanner and an imaging device. The reading device 260 may be an external device coupled to a main body of the printer 200.

The controller 210 includes a CPU 211, a ROM 212, a RAM 213, a drive signal transmission unit, and the like, and controls operations of the communication I/F 220, the printing head 230, the drive unit 250, and the like. The controller 210 controls the dispensing of the ink droplets 237 by the printing head 230 according to the dot data included in the print data PD1 acquired from the print server 102. The controller 210 may control a relative movement between the printing medium ME0 and the printing head 230 by the drive unit 250. In this way, the print image IM0 corresponding to the print data PD1 is formed at the printing medium ME0. The controller 210 can be formed of a system on a chip (SoC) or the like.

The communication I/F 220 is coupled to the network NE1 and inputs and outputs information to and from the server 100.

The printing head 230 includes a drive circuit, a drive element, and the like, and performs printing by dispensing the ink droplets 237 onto the printing medium ME0 from a plurality of nozzles 234 included in a nozzle row 233. Here, the nozzle means a small opening through which ink droplets are dispensed, and the nozzle row means an arrangement of the plurality of nozzles. The printing head 230 shown in FIG. 2 includes a C nozzle row 23C that dispenses C ink droplets 237, an M nozzle row 23M that dispenses M ink droplets 237, a Y nozzle row 23Y that dispenses Y ink droplets 237, and a K nozzle row 23K that dispenses K ink droplets 237. The drive elements can, for example, each be a piezoelectric element that applies a pressure to an ink in a pressure chamber that communicates with the nozzles 234, or a drive element that dispenses the ink droplets 237, from the nozzles 234 by generating bubbles in the pressure chamber with the aid of heat. For example, when binary dot data based on the print data is “dot formation”, the controller 210 outputs a drive signal for dispensing ink droplets for dot formation to the printing head 230. When the dot data is data of three or more values, the controller 210 outputs a drive signal for dispensing an ink droplet for a large dot when the dot data is “large dot formation”, and outputs a drive signal for dispensing an ink droplet for a small dot when the dot data is “small dot formation”.

The printing medium ME0 is not particularly limited, and includes paper, fabric, resin, metal, and the like. The shape of the printing medium ME0 may be a cut two-dimensional shape or a roll shape.

As shown in FIG. 3, the chart CH0 on the printing medium ME0 includes a plurality of pattern arrays P0 including a plurality of patches PA0 having different dispensing amounts of the ink 236. The plurality of pattern arrays P0 shown in FIG. 3 include pattern arrays P11, P12, P13, and P14 of a primary color, pattern arrays P21, P22, and so on of a secondary color, and a pattern array P31 of a tertiary color. The primary color is a color expressed by only one type of ink, the secondary color is a color expressed by two types of inks having different colors, and the tertiary color is a color expressed by three types of inks having different colors. In each of the pattern arrays P0, the patches PA0 are arranged in an ink amount order QO1 that means an order of the ink amount Q1 per unit area. The patch PA0 collectively refers to a trained patch PA1 included in the trained chart CH1 and the test patch PA2 included in the test chart CH2.

As a schematically simplified example, 5×5=25 pixels PX0 are shown as a predetermined number of pixels PX0 corresponding to a unit area in a region surrounded by a two-dot chain line in FIG. 3. Obviously, the predetermined number corresponding to the unit area is not limited to 25, and a larger area may be treated as the unit area. The ink amount Q1 per unit area means a ratio (including percentage) of the number of ink droplets 237 dispensed to the predetermined number of pixels PX0, and means a ratio when converted to the largest ink droplet when the ink droplets 237 having different sizes are dispensed to the pixel PX0. The area surrounded by the two-dot chain line in FIG. 3 indicates that the ink amount Q1 per unit area of the patch PA0 is (20/25)×100=80%. When a mixed color image of a secondary color or the like is formed, since a plurality of types of ink droplets 237 are dispensed to one pixel PX0, Q1 >100% may be satisfied. For example, the ink amount Q1 per unit area of the secondary color is 200% at maximum.

The server 100 receives the color material value information 160 from the terminal 180 in order to identify each of the patches PA0 in the chart CH0. The color material value information 160 in the present specific example includes the type of the ink 236 to be used for printing the patch PA0 in addition to the ink amount Q1 per unit area of each patch PA0.

Each patch PA0 is a quadrangle and includes a plurality of solid regions PA3 and a plurality of line regions PA4. In FIG. 3, four solid regions PA3 are present in each patch PA0, and the line region PA4 is present between the solid regions PA3. The solid region PA3 means a region in which the type of the ink 236 does not change and the ink amount Q1 per unit area is uniform. The line region PA4 in which the ink 236 is dispensed also means a region in which the type of the ink 236 does not change and the ink amount Q1 per unit area is uniform. For example, the primary color pattern array P11 includes a C solid region PA3 and an M line region PA4, and the primary color pattern array P12 includes an M solid region PA3 and a Y line region PA4. The secondary color pattern arrays P21, P22, and so on include a secondary color solid region PA3, and may include a secondary color line region PA4. The line region PA4 may be a region where the ink 236 is not dispensed.

By observing the printing medium ME0 on which the plurality of patches PA0 having different ink amounts Q1 per unit area are formed, it is possible to determine a relationship between the phenomenon such as “interruption” of the line region PA4, “thinning” of the line region PA4, “thickening” of the line region PA4, “adjacent” of the line region PA4, “bleeding” of the ink, “aggregation” of the ink, and “overflow” of the ink, and the ink amount Q1 per unit area. The “interruption” of the line region PA4 means a phenomenon in which a part of the line region PA4 is missing. The “thinning” of the line region PA4 means a phenomenon in which a width of the line region PA4 is smaller than an original width of the line region PA4 although the “thinning” does not lead to “interruption”. The “thickening” of the line region PA4 means a phenomenon in which the line region PA4 is thicker than the original width thereof. The “bleeding” of the ink means a phenomenon in which an outline of the patch PA0 is ambiguous due to bleeding of the ink to the surroundings. The “aggregation” of the ink means a phenomenon in which the dispersibility of ink dots decreases due to aggregation of color materials. The “overflow” of the ink means a phenomenon in which the shape of the patch PA0 collapses due to the ink protruding from the region of the original patch PA0. These phenomena are described in JP-A-2021-24152.

When the maximum ink amount Qm (see FIG. 10), which is the upper limit of the ink amount Q1 per unit area in the printing medium ME0, is too large, the color of a dark region in the print image IM0 is saturated, and thus the image quality decreases. On the other hand, when the maximum ink amount Qm is too small, the color development of the print image IM0 decreases. As a result of the repeated test, it is found that the above-described phenomena occur locally in the patch PA0 instead of the entire patch PA0, and the local phenomena affect the image quality of the print image IM0.

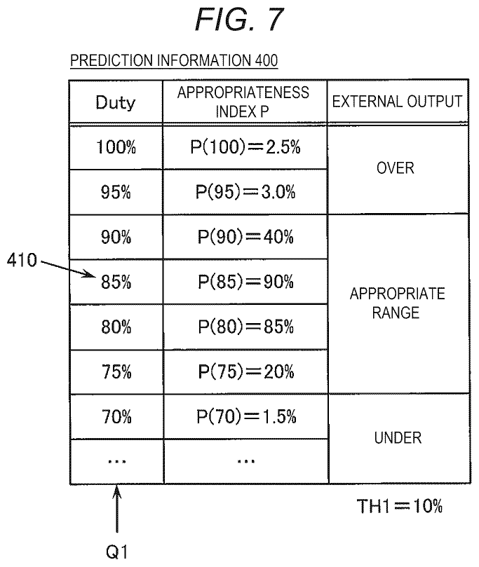

Therefore, as shown in FIGS. 4 to 6, the trained model generation device 2 in the present specific example generates the trained model 300 for acquiring a predicted value PV1 indicating the probability that the ink amount Q1 per unit area of each divided test image 142 is appropriate as the maximum ink amount Qm. Here, when the recommended value obtained from an inference result of the trained model 300 is automatically determined as the maximum ink amount Qm, even when the user cannot satisfy the determined maximum ink amount Qm, the color conversion LUT is generated according to the inference result. Therefore, as shown in FIGS. 7 and 8, the support device 3 in the present specific example provides the user with prediction information 400 indicating whether the ink amount Q1 per unit area of each test image 141 is in the appropriate range of the maximum ink amount Qm or out of the appropriate range. The trained model generation device 2 and the support device 3 are positioned to support the determination of the maximum ink amount Qm by the user.

FIG. 4 schematically shows the training chart image 120 and the test chart image 140. FIG. 4 collectively shows the training chart image 120 and the test chart image 140.

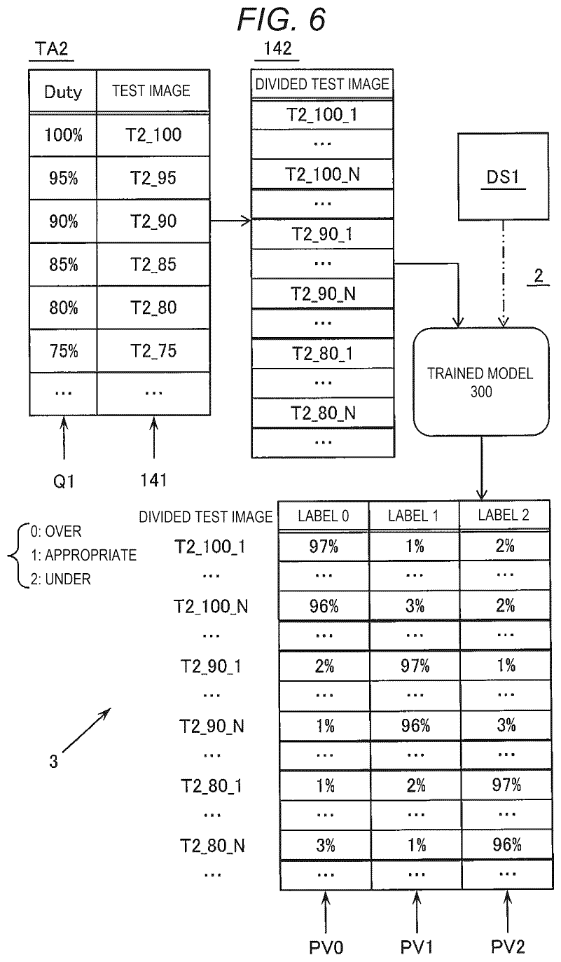

The training chart image 120 is obtained by reading the trained chart CH1 shown in FIG. 3 by, for example, the reading device 260 (see FIG. 2). When reading the trained chart CH1 on the print image IM0, the reading device 260 generates a plurality of training images 121 respectively corresponding to the plurality of trained patches PA1 included in the trained chart CH1. Therefore, the plurality of training images 121 are obtained by reading the plurality of trained patches PA1 having different ink amounts Q1 per unit area. The plurality of training images 121 are transmitted to the AI server 101 via the network NE1. Upon receiving the plurality of training images 121, the AI server 101 holds the plurality of training images 121 in the RAM 113. The AI server 101 may store the plurality of training images 121 in the storage device 114. In order to generate the trained model 300 shown in FIG. 6, each of the training images 121 is divided vertically and horizontally into N divided training images 122.

The test chart image 140 is obtained by reading the test chart CH2 shown in FIG. 3 by, for example, the reading device 184 (see FIG. 1). When reading the test chart CH2 on the print image IM0, the reading device 184 generates a plurality of test images 141 respectively corresponding to the plurality of test patches PA2 included in the test chart CH2. Therefore, the plurality of test images 141 are obtained by reading the plurality of test patches PA2 having different ink amounts Q1 per unit area. The plurality of test images 141 are transmitted to the AI server 101 via the network NE1. Upon receiving the plurality of test images 141, the AI server 101 holds the plurality of test images 141 in the RAM 113. The AI server 101 may store a plurality of test images 141 in the storage device 114. Since the trained model 300 shown in FIG. 6 is used, each of the test images 141 is divided vertically and horizontally into N divided test images 142. That is, the number of divisions of the test image 141 is the same as the number of divisions N of the training image 121.

The number of divisions N is not particularly limited, and may be a number capable of detecting the above-described phenomenon, such as 50 to 5000.

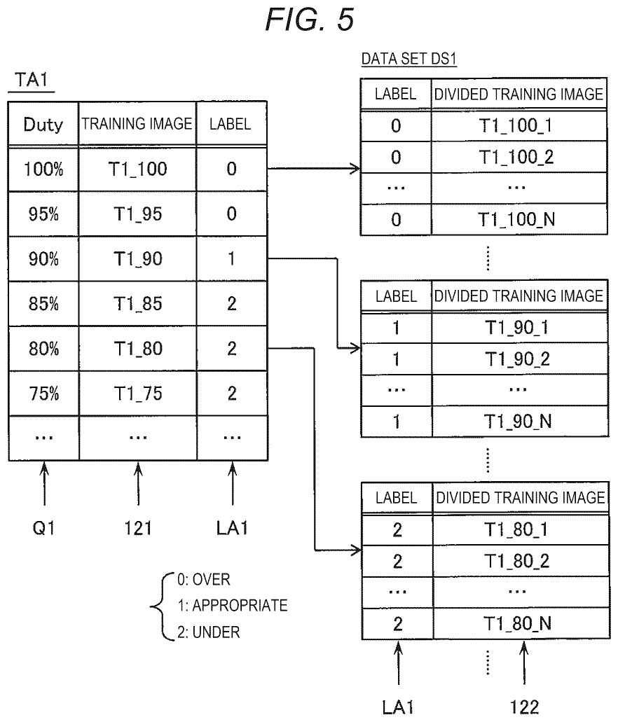

FIG. 5 schematically shows an example of generating a data set DS1 from a plurality of training images 121 having different ink amounts Q1 per unit area. “Duty” of a label table TA1 shown in FIG. 5 means the ink amount Q1 per unit area.

First, as shown in the label table TA1, an operation of associating the training image 121 with a label LA1 is performed for each ink amount Q1 per unit area. In each label LA1 shown in FIG. 5, the ink amount Q1 per unit area of the corresponding trained patch PA1 is “1” when the ink amount Q1 is appropriate as the maximum ink amount Qm, “0” when the ink amount Q1 exceeds the appropriate ink amount Qm, and “2” when the ink amount Q1 falls below the appropriate ink amount Qm. The label LA1 indicates whether the ink amount Q1 per unit area of each of the trained patches PA1 is appropriate as the maximum ink amount Qm, exceeds the appropriate amount, or falls below the appropriate amount. Obviously, the numerical value of the label LA1 can be changed as appropriate. In this specific example, the label table TA1 is generated for each pattern array P0 shown in FIGS. 3 and 4. The label LA1 is given by an observer who views the trained chart CH1. That is, for each pattern array P0, the observer assigns a label “1” to the ink amount Q1 per unit area of the trained patch PA1 determined to be appropriate as the maximum ink amount Qm, assigns a label “0” to the ink amount Q1 per unit area of the trained patch PA1 determined to be more than appropriate as the maximum ink amount Qm, and assigns the label “2” to the ink amount Q1 per unit area of the trained patch PA1 determined to be less than appropriate as the maximum ink amount Qm. In this specific example, the ink amount Q1 per unit area to which the label “1” that means “appropriate” is applied for each pattern array P0 is one.

Next, each of the training images 121 is divided into N divided training images 122, and processing of associating the label LA1 corresponding to the original training image 121 with all the divided training images 122 is performed. For example, the trained model generation device 2 divides the training image “T1_100” of Q1=100% into N divided training images of “T1_100_1” to “T1_100_N”, and associates the label “0” of Q1=100% with all the divided training images of “T1_100_1” to “T1_100_N”. The trained model generation device 2 divides the training image “T1_90” of Q1=90% into N divided training images of “T1_90_1” to “T1_90_N”, and associates the label “1” of Q1=90% with all the divided training images of “T1_90_1” to “T1_90_N”. The trained model generation device 2 divides the training image “T1_80” of Q1=80% into N divided training images “T1_80_1” to “T1_80_N”, and associates the label “2” of Q1=80% with all the divided training images “T1_80_1” to “T1_80_N”. A collection of these pieces of data is the data set DS1 input to a neural network serving as the trained model 300.

FIG. 6 schematically shows the trained model 300 generated by the trained model generation device 2 and used by the support device 3. The trained model generation device 2 in the present specific example generates the trained model 300 for each type of the printing medium ME0, and further generates the trained model 300 for each pattern array P0. When an output resolution of the printer 200 can be changed, the trained model generation device 2 may further generate the trained model 300 for each output resolution.

The trained model generation device 2 generates the trained model 300 by inputting the data set DS1 in which the label LA1 is associated with all the divided training images 122 to the neural network. The trained model generation device 2 repeatedly performs machine learning of the provisional trained model 300 so that the probability that the output is the label LA1 with respect to the input of the divided training image 122 increases. For example, the trained model 300 calculates a feature vector for distinguishing the label LA1 from each divided training image 122 for each input to the provisional trained model 300, and repeatedly performs the above-described machine learning based on the feature vector. The neural network performs the machine learning based on the relationship between the label LA1 and the plurality of divided training images 122. By inputting the divided test image 142, the obtained trained model 300 can output a predicted value PV0 indicating a probability that the divided test image 142 corresponds to the label “0”, a predicted value PV1 indicating a probability that the divided test image 142 corresponds to the label “1”, and a predicted value PV2 indicating a probability that the divided test image 142 corresponds to the label “2”. The trained model 300 causes the AI server 101 to function to acquire the predicted value PV1 indicating the probability that the ink amount Q1 per unit area of the divided test image 142 is appropriate as the maximum ink amount Qm based on the divided test image 142.

In order to input the plurality of divided test images 142 to the trained model 300, first, as shown in the test image table TA2, an operation of associating the test image 141 with each ink amount Q1 per unit area is performed. Next, processing of dividing each of the test images 141 into the N divided test images 142 is performed. For example, the support device 3 divides the test image of “T2_100” of Q=100% into N divided test images of “T2_100_1” to “T2_100_N”. The support device 3 divides a test image “T2_90” of Q=90% into N divided test images of “T2_90_1” to “T2_90_N”, and divides a test image of “T2_80” of Q=80% into N divided test images of “T2_80_1” to “T2_80_N”. These divided test images 142 are input to the trained model 300, and the predicted value PV1 output from the trained model 300 is obtained for each of the divided test images 142.

However, since there are N predicted values PV1 for each ink amount Q1 per unit area, the support device 3 calculates the appropriateness index P by performing statistical processing on the N predicted values PV1 for each ink amount Q1 per unit area. When averaging processing is performed as the statistical processing, the support device 3 calculates an arithmetic mean of the N predicted values PV1 as the appropriateness index P. Obviously, instead of the arithmetic mean, a geometric mean or the like may be calculated. In addition, the support device 3 may arrange the N predicted values PV1 in order (ascending order or descending order) and calculate a median value of the N predicted values PV1 as the appropriateness index P according to the order. In either case, the appropriateness index P indicates the probability that the ink amount Q1 per unit area corresponding to the test image 141 is appropriate.

FIG. 7 schematically shows an example of the prediction information 400 indicating whether the ink amount Q1 per unit area of each test image 141 is in the appropriate range of the maximum ink amount Qm or out of the appropriate range.

As shown in FIG. 7, the calculated appropriateness index P is associated with each ink amount Q1 per unit area, and the report information 500 indicates whether the ink amount Q1 per unit area is in the “appropriate range”, “over” exceeding the appropriate range, or “under” falling below the appropriate range with reference to the threshold TH1. The threshold TH1 is applied to the appropriateness index P for each ink amount Q1 per unit area. In the example shown in FIG. 7, when the threshold TH1 is 10% and the ink amount Q1 per unit area is 75% to 90%, the appropriateness indices P(75), P(80), P(85), and P(90) are greater than the threshold TH1, and thus the “appropriate range” is obtained. When the ink amount Q1 per unit area is 95% to 100%, the appropriate indices P(95) and P(100) are equal to or less than the threshold TH1, and Q1=95% to 100% exceed the ink amount 75% to 90% per unit area in the appropriate range, and thus “over” is obtained. When the ink amount Q1 per unit area is equal to or less than 70%, the appropriateness index P(70) is equal to or less than the threshold TH1, and Q1≤70% is less than the ink amount 75% to 90% per unit area of the appropriate range, and thus “under” is obtained. The prediction information 400 shown in FIG. 7 indicates whether the ink amount Q1 per unit area of the test image 141 is in the appropriate range of the maximum ink amount Qm, exceeds the appropriate range, or falls below the appropriate range.

Further, the ink amount Q1 per unit area in the appropriate range includes the recommended value 410 of the maximum ink amount Qm. The support device 3 determines the recommended value 410 of the maximum ink amount Qm based on the ink amount Q1 per unit area corresponding to each test image 141 and the appropriateness index P. The recommended value 410 may be the ink amount Q1 per unit area having the largest appropriateness index P. Alternatively, the recommended value 410 may be the ink amount per unit area at the center included in the top three ink amounts Q1 per unit area when the ink amounts Q1 per unit area are arranged in the order of the appropriateness index P (ascending order or descending order). In the example shown in FIG. 7, the top three ink amounts Q1 per unit area are 80%, 85%, and 90% in the appropriate range, and Q1=85% at the center thereof is the recommended value 410.

FIG. 8 schematically shows a display example of the report information 500 including the overall image display part 501 and the recommended portion display part 502.

The overall image display part 501 shows an overall image of the test chart CH2 including the plurality of test patches PA2. In the overall image display part 501, a plurality of display patches 510 respectively corresponding to the plurality of test patches PA2 are disposed. The plurality of display patches 510 include, for each pattern array P0, a plurality of appropriate range patches 511 in which the corresponding ink amount Q1 per unit area is in the appropriate range, and a plurality of inappropriate range patches 512 that are not the appropriate range patches 511. The plurality of inappropriate range patches 512 include a plurality of display patches exceeding the appropriate range and a plurality of display patches falling below the appropriate range. Therefore, the inappropriate range patch above the appropriate range patch 511 among the plurality of inappropriate range patches 512 for each pattern array P0 indicates that the ink amount Q1 per unit area of the test image 141 exceeds the appropriate range of the maximum ink amount Qm. The inappropriate range patch below the appropriate range patch 511 among the plurality of inappropriate range patches 512 for each pattern array P0 indicates that the ink amount Q1 per unit area of the test image 141 falls below the appropriate range of the maximum ink amount Qm. In the overall image display part 501, appropriate range information 515 for distinguishing the plurality of appropriate range patches 511 in the appropriate range among the plurality of test patches PA2 from the remaining plurality of inappropriate range patches 512 is included in the overall image of the test chart CH2.

For example, as shown in FIG. 8, the AI server 101 includes, in the overall image of the test chart CH2, the appropriate range information 515 that makes the plurality of appropriate range patches 511 stand out by hiding the plurality of inappropriate range patches 512 in the overall image display part 501. The hiding of the inappropriate range patch 512 means making the solid region PA3 and the line region PA4 of the inappropriate range patch 512 invisible. The color for hiding the inappropriate range patch 512 is not particularly limited, such as gray, black, or red. In addition, the AI server 101 may include, in the overall image of the test chart CH2, the appropriate range information 515 that makes the plurality of appropriate range patches 511 stand out by thinning the plurality of inappropriate range patches 512 in the overall image display part 501. The thinning of the inappropriate range patch 512 means making the solid region PA3 and the line region PA4 of the inappropriate range patch 512 visible. The color for thinning the inappropriate range patch 512 is not particularly limited, such as gray, black, or red.

In both cases, the appropriate range information 515 is information that distinguishes the plurality of appropriate range patches 511 from the plurality of inappropriate range patches 512 as the prediction information 400.

In addition to the prediction information 400, the AI server 101 may include a recommended patch 520 indicating a recommended value 410 shown in FIG. 7 in the overall image display part 501. The overall image display part 501 shown in FIG. 8 includes the recommended patch 520 for each pattern array P0. Each recommended patch 520 shown in FIG. 8 is surrounded by a thick line so as to stand out. The recommended patch 520 is an example of recommendation information. Since the recommended patch 520 is displayed in the recommended portion display part 502, the recommended patch 520 in the overall image display part 501 may be made lighter or hidden by being superimposed with a standing-out color or the like.

The recommended portion display part 502 indicates the recommended patch 520 corresponding to the recommended value 410 of the maximum ink amount Qm among the plurality of test patches PA2. In the recommended portion display part 502, the recommended patch 520 of each pattern array P0 is disposed. The AI server 101 generates the report information 500 such that the recommended patch 520 is equal to or larger than the size of each of the test patches PA2 (see FIG. 3) in the test chart CH2. FIG. 8 shows that there are six recommended patches 520 of the primary color indicated as “single color”, three recommended patches 520 of the secondary color, and one recommended patch 520 of the tertiary color. In the recommended portion display part 502, the reliability information 530 indicating the reliability of the recommended value 410 is added to each recommended patch 520. Although details will be described later, the reliability information 530 can be generated by, for example, a method shown in FIGS. 12 and 13. The reliability information 530 shown in FIG. 8 is indicated by a color graphic 531 indicating that the reliability of the recommended value 410 is high, a color graphic 532 indicating that the reliability of the recommended value 410 is medium, and a color graphic 533 indicating that the reliability of the recommended value 410 is low under each recommended patch 520. The report information 500 shown in FIG. 8 also includes description fields of these color graphics 531 to 533. A display position of the reliability information 530 may be above each recommended patch 520, to the left of each recommended patch 520, to the right of each recommended patch 520, or the like, in addition to below each recommended patch 520. The shapes of the color graphics 531 to 533 are not limited to rectangular shapes, and may be circular, triangular, star-shaped, or the like, or may be icons or the like. In addition, the reliability information 530 may be character information such as high, medium, and low in addition to color coding.

In the recommended portion display part 502 shown in FIG. 8, the warning information 550 may be added to the recommended patch 520 having low reliability of the recommended value 410. The warning information 550 indicates that the reliability information 530 is lower than a predetermined reference. The display position of the warning information 550 may be not only above the recommended patch 520 but also below the recommended patch 520, left of the recommended patch 520, right of the recommended patch 520, and the like. The warning information 550 may be displayed in a portion other than the recommended portion display part 502 in the report information 500.

The report information 500 may include the consideration information 540 indicating consideration for determination of the recommended value 410. FIG. 8 shows, as an example, the consideration information 540 based on the reliability information 530 of the recommended value 70% corresponding to the recommended patch 520 in a fifth column of single color.

### 3. Specific Example of Trained Model Generation Processing

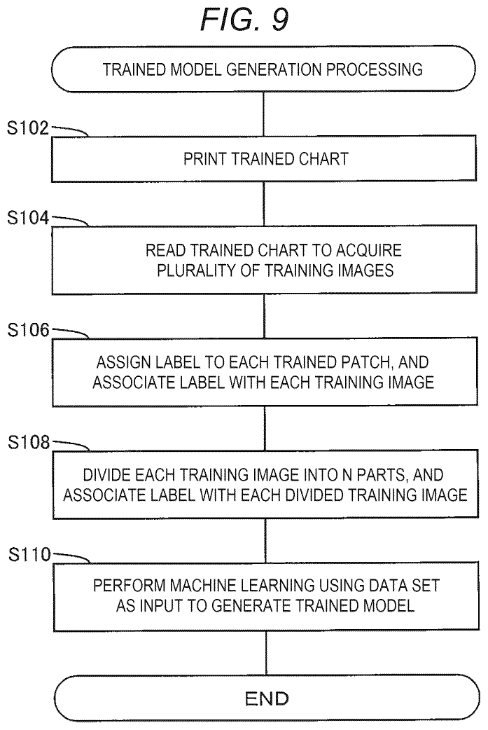

FIG. 9 schematically shows trained model generation processing performed by the trained model generation device 2. Hereinafter, the trained model generation processing of steps S102 to S110 will be described with reference to FIGS. 1 to 6. The description of the “step” is omitted, and the reference numeral of the step may be shown in parentheses.

A subject of the trained model generation processing is the processing unit 110 of the AI server 101 shown in FIGS. 1 and 2. The trained model generation processing is started when the AI server 101 receives an instruction for generating the trained model 300 from the terminal 180 or the input device 115.

When the trained model generation processing is started, the processing unit 110 performs control of forming the trained chart CH1 as shown in FIG. 3 on the printing medium ME0 in (S102). As described above, the trained chart CH1 includes a plurality of trained patches PA1 having different ink amounts Q1 per unit area. For example, the storage device 114 stores trained chart print data for causing the reference printer 201 to print the trained chart CH1, and the processing unit 110 transmits the trained chart print data to the reference printer 201, so that the trained chart CH1 is formed on the printing medium ME0. When the trained chart CH1 is prepared, the processing of S102 may be omitted.

Next, the processing unit 110 causes the reading device 260 to read the trained chart CH1 on the printing medium ME0, acquires the generated training chart image 120 (see FIG. 4), and stores the training chart image 120 in the RAM 113 (S104). The training chart image 120 includes a plurality of training images 121 respectively corresponding to a plurality of trained patches PA1 having different ink amounts Q1 per unit area.

Next, the processing unit 110 performs processing of assigning the label LA1 to each trained patch PA1, and associates the label LA1 with each training image 121 as in the label table TA1 shown in FIG. 5 (S106). As described above, the label LA1 indicates whether the ink amount Q1 per unit area of each of the trained patches PA1 is appropriate as the maximum ink amount Qm, exceeds the appropriate amount, or falls below the appropriate amount. The processing of assigning the label LA1 may be processing of receiving an input of a numerical value of the label LA1 for each of the trained patches PA1 via the input device 115. In this case, the observer of the trained chart CH1 may input “1” when the ink amount Q1 per unit area of the trained patch PA1 is appropriate as the maximum ink amount Qm, input “0” when the ink amount Q1 per unit area of the trained patch PA1 exceeds the appropriate ink amount Qm, and input “2” when the ink amount Q1 per unit area of the trained patch PA1 falls below the appropriate ink amount Qm. When the numerical value of the label LA1 is input, the processing unit 110 generates the label table TA1 by associating the training image 121 with the numerical value of the label LA1 for each ink amount Q1 per unit area for each pattern array P0.

Next, the processing unit 110 generates the data set DS1 as shown in FIG. 5 (S108). At this time, the processing unit 110 divides each of the training images 121 into the N divided training images 122, and associates the label LA1 corresponding to the original training image 121 with all the divided training images 122. Accordingly, the data set DS1 in which the label LA1 is associated with each of the divided training images 122 is generated for each of the pattern arrays P0.

Finally, the processing unit 110 performs the machine learning using the data set DS1 as an input, and generates the trained model 300 (S110). As shown in FIG. 6, the trained model 300 causes the server 100 to function to acquire the predicted values PV0, PV1, and PV2 indicating the probability that the divided test image 142 corresponds to the label LA1 by inputting the divided test image 142. The processing unit 110 generates the trained model 300 described above by the machine learning based on the relationship between the label LA1 and the plurality of divided training images 122.

### 4. Specific Example of Report Output Processing

FIG. 10 schematically shows report output processing performed by the support device 3. Here, S202 corresponds to a reception step ST1. S204 corresponds to a prediction step ST2. S206 corresponds to an overall image processing step ST3. S208 corresponds to a recommended portion processing step ST4. S210 corresponds to a consideration information adding step ST5. S212 corresponds to a transmission step ST6. FIG. 11 schematically shows prediction processing of the maximum ink amount Qm performed in S204 of FIG. 10. Hereinafter, with reference to FIGS. 1 to 8, the report output processing in S202 to S212 will be described.

The subject of the report output processing is the processing unit 110 of the AI server 101 and the print server 102. The report output processing starts when the AI server 101 receives an instruction for determining the maximum ink amount Qm from the terminal 180.

The terminal 180 shown in FIG. 1 causes the printer 200 to print the test chart CH2 as shown in FIG. 3. As described above, the test chart CH2 includes a plurality of test patches PA2 having different ink amounts Q1 per unit area. For example, the test chart CH2 is formed on the printing medium ME0 by the terminal 180 storing the test chart print data for causing the printer 200 to print the test chart CH2 and the terminal 180 transmitting the test chart print data to the printer 200 directly or via the network NE1.

When the terminal 180 reads the test chart CH2 and transmits the obtained test chart image 140 and the color material value information 160 indicating the ink amount Q1 per unit area of each test patch PA2 to the AI server 101 via the network NE1, the processing unit 110 of the AI server 101 starts report output processing.

When the report output processing starts, the processing unit 110 of the AI server 101 receives the test chart image 140 and the color material value information 160 from the terminal 180 via the network NE1 and stores the image and the information in the RAM 113 (S202). The test chart image 140 includes a plurality of test images 141 respectively corresponding to a plurality of test patches PA2 having different ink amounts Q1 per unit area.

Next, the processing unit 110 of the AI server 101 performs prediction processing of the maximum ink amount Qm (see FIG. 11) (S204).

When the prediction processing shown in FIG. 11 starts, the processing unit 110 acquires each of the test images 141 associated with the ink amount Q1 per unit area from the test chart image 140 based on the test chart image 140 and the color material value information 160 (S302). The color material value information 160 indicates the ink amount Q1 per unit area of each test patch PA2 on the printing medium ME0 and the type of the ink 236. Therefore, the processing unit 110 extracts each test image 141 from the test chart image 140, and associates the ink amount Q1 per unit area and the type of the ink 236 with each test image 141 according to the color material value information 160.

Next, the processing unit 110 acquires the N divided test images 142 by dividing each of the test images 141 into N pieces (S304).

Next, the processing unit 110 acquires the predicted value PV1 (see FIG. 6) of the label “1” that means the appropriate range by executing the trained model 300 using each of the divided test images 142 as an input (S306). In S306, N predicted values PV1 are acquired for each of the divided test images 142. In S306, the processing unit 110 may acquire the predicted value PV0 of the label “0” that means exceeding the appropriate range, or may acquire the predicted value PV2 of the label “2” that means falling below the appropriate range.

Next, the processing unit 110 performs statistical processing on the N predicted values PV1 obtained by executing the trained model 300 for each of the test images 141 to calculate the appropriateness index P as shown in FIG. 7 (S308). For example, the processing unit 110 calculates the arithmetic mean of the N predicted values PV1 as the appropriateness index P for each of the test images 141. As described above, the appropriateness index P indicates the probability that the ink amount Q1 per unit area corresponding to the test image 141 is appropriate. N predicted values PV0 may be added to the calculation of the appropriateness index P, and N predicted values PV2 may be added to the calculation of the appropriateness index P.

Next, the processing unit 110 classifies the ink amount Q1 per unit area in which the appropriateness index P exceeds the threshold TH1 into the “appropriate range” (S310). In the example shown in FIG. 7, since the appropriateness indices P(75), P(80), P(85), and P(90) are greater than the threshold TH1, Q1=75% to 90% is classified as the “appropriate range”. The processing unit 110 determines that the ink amount Q1 per unit area in which the calculated appropriateness index P exceeds the threshold TH1 is within the appropriate range. In S310, the processing unit 110 may classify the ink amount Q1 per unit area in which the appropriateness index P does not exceed the threshold TH1 into “over” or “under”. In the example shown in FIG. 7, since the appropriateness indices P(95) and P(100) satisfying Q1>90% are equal to or less than the threshold TH1, Q1=95% to 100% is classified as “over”. Since the appropriateness index P(70) of Q1<75% is equal to or less than the threshold TH1, Q1≤70% is classified as “under”. The classification of the S310 may be further performed for each type of the printing medium ME0 and for each pattern array P0, and may be performed for each output resolution.

As described above, the processing unit 110 determines, based on the color material value information 160 and the test chart image 140, whether the ink amount Q1 per unit area corresponding to each of the test patches PA2 is within the appropriate range of the maximum ink amount Qm. The processing unit 110 determines an appropriate range of the ink amount Q1 per unit area for the maximum ink amount Qm.

Next, the processing unit 110 determines the recommended value 410 (see FIG. 7) of the maximum ink amount Qm from the ink amount Q1 per unit area in the appropriate range (S312). For example, the processing unit 110 determines the ink amount per unit area having the largest appropriateness index P among the ink amounts Q1 per unit area in the appropriate range as the recommended value 410. Alternatively, the processing unit 110 may determine, as the recommended value 410, the ink amount per unit area at the center included in the upper three ink amounts per unit area of the appropriateness index P among the ink amounts Q1 per unit area of the appropriate range.

As described above, the processing unit 110 determines, based on the color material value information 160 and the test chart image 140, the recommended value 410 from the appropriate range for the maximum ink amount Qm.

Next, the processing unit 110 generates the reliability information 530 indicating the reliability of the recommended value 410 based on the color material value information 160 and the test chart image 140 (S314).

FIGS. 12 and 13 schematically show an example of generating the reliability information 530.

FIG. 12 shows an example of generating the reliability information 530 by performing statistical processing on the appropriateness index P (Duty) for each pattern array P0. The appropriateness index P (Duty) means the appropriateness index P that changes according to the ink amount Q1 per unit area indicated by “Duty” in the drawing, and is determined based on the color material value information 160 and the test chart image 140. In the example shown in FIG. 7, the appropriateness index P (Duty) corresponds to P(100)=2.5%, P(95)=3.0%, P(90)=40%, and so on. Here, it is assumed that the number of appropriateness indices P (Duty) of each pattern array P0 is n, a variable for identifying each of appropriateness indices P (Duty) is j, and the appropriateness index P (Duty) corresponding to the variable j is Pj. For example, the processing unit 110 can generate the reliability information 530 according to the thresholds TS1 and TS2 by calculating an arithmetic mean Avg=(1/n)ΣPj of the n appropriateness indices Pj, and calculates the variance σ²=(1/n)Σ(Pj−Avg) of the n appropriateness indices Pj, and can generate the reliability information 530 according to the thresholds TS1 and TS2. 0<TS1<TS2. For example, when the variance σ² is smaller than the threshold TS1, the processing unit 110 determines the color graphic 531 indicating high reliability as the reliability information 530. When the variance σ² is greater than the threshold TS2, the processing unit 110 determines the color graphic 533 indicating low reliability as the reliability information 530. In addition, σ²>TS2 means that the reliability information 530 is smaller than the predetermined reference. Therefore, as shown in FIG. 8, the warning information 550 is added to the recommended patch 520 corresponding to σ²>TS2. When the variance σ² is equal to or greater than the threshold TS1 and equal to or smaller than the threshold TS2, the processing unit 110 determines the color graphic 532 indicating that the reliability is medium as the reliability information 530.

FIG. 12 shows graphs 431, 432, and 433 of the appropriateness index P (Duty) with respect to the ink amount Q1 per unit area. Since a peak of the graph 431 is relatively steep, a variance σ²=s1 corresponding to the graph 431 is relatively small. Since the peak of the graph 433 is relatively gentle, a variance σ²=s3 corresponding to the graph 433 is relatively large. Since the peak of the graph 432 is between the peaks of the graphs 431 and 433, a variance σ²=s2 corresponding to the graph 432 is greater than the variance s1 and smaller than the variance s3. In the example shown in FIG. 12, since the variance s1 is smaller than the threshold TS1, the reliability information 530 added to the recommended patch 520 corresponding to the graph 431 is determined to be the high-reliability graphic 531. Since the variance s2 is equal to or greater than the threshold TS1 and equal to or smaller than the threshold TS2, the reliability information 530 added to the recommended patch 520 corresponding to the graph 432 is determined to be the graphic 532 having the medium-reliability. Since the variance s3 is greater than the threshold TS2, the reliability information 530 added to the recommended patch 520 corresponding to the graph 433 is determined to be the low-reliability graphic 533.

The statistical processing of the appropriateness index P (Duty) is not limited to the calculation processing of the variance σ², and may be the calculation processing of the standard deviation σ or the like. The reliability information 530 can also be generated based on the maximum value of the appropriateness index P (Duty) or the like.

FIG. 13 shows an example in which the reliability information 530 is generated based on the index indicating the performance of the trained model 300 for each pattern array P0. For example, when the AI server 101 generates the trained model 300 for each pattern array P0, the AI server 101 calculates a precision ratio indicating a ratio of the number of samples actually appropriate to the number of samples predicted to be appropriate by the trained model 300, a recall ratio indicating a ratio of the number of samples predicted to be appropriate to the number of appropriate samples, and an F1 score. The F1 score is a harmonic average of the precision ratio and the recall ratio, and is an example of an index indicating the performance of the trained model 300. Therefore, when the AI server 101 stores the F1 score for each pattern array P0 in the storage device 114 as an F1 score table TA3, the AI server 101 can generate the reliability information 530 according to the thresholds TR1 and TR2. 0<TR1<TR2. FIG. 13 shows that F1 scores FS1 to FS10 for each pattern array P0 are stored in the F1 score table TA3.

For example, when the F1 score is smaller than the threshold TR1, the processing unit 110 of the AI server 101 determines the color graphic 533 indicating low reliability as the reliability information 530. Since the F1 score FS5 shown in FIG. 13 is smaller than the threshold TR1, the reliability information 530 added to the recommended patch 520 included in the pattern array P of the “fifth column of single color” is determined to be the low-reliability graphic 533. The F1 score is smaller than the threshold TR1 means that the reliability information 530 is lower than a predetermined reference. Therefore, as shown in FIG. 8, the warning information 550 is added to the recommended patch 520 corresponding to FS5<TR1. When the F1 score is greater than the threshold TR2, the processing unit 110 determines the color graphic 531 indicating high reliability as the reliability information 530. Since the F1 score FS3 shown in FIG. 13 is greater than the threshold TR2, the reliability information 530 added to the recommended patch 520 included in the pattern array P of the “third column of single color” is determined to be the high-reliability graphic 531. When the F1 score is equal to or greater than the threshold TR1 and equal to or less than the threshold TR2, the processing unit 110 determines the color graphic 532 indicating that the reliability is medium as the reliability information 530. Since the F1 score FS4 shown in FIG. 13 is equal to or greater than the threshold TR1 and equal to or smaller than the threshold TR2, the reliability information 530 added to the recommended patch 520 included in the pattern array P of the “fourth column of single color” is determined to be the medium-reliability graphic 532.

The index indicating the performance of the trained model 300 is not limited to the F1 score, and may be a precision ratio, a recall ratio, or the like.

The processing unit 110 may generate first reliability information based on the index indicating the performance of the trained model 300 and second reliability information based on the statistical processing as shown in FIG. 12, and determine the information having lower reliability between the first reliability information and the second reliability information as the final reliability information 530. For example, when the reliability indicated by the first reliability information is low, the color graphic 533 indicating that the reliability is low is determined as the reliability information 530 regardless of the second reliability information. When the reliability indicated by the second reliability information is low, the color graphic 533 indicating that the reliability is low is determined as the reliability information 530 regardless of the first reliability information. When the reliability indicated by the first reliability information is medium, if the reliability indicated by the second reliability information is medium or high, the color graphic 532 indicating that the reliability is medium is determined as the reliability information 530. When both the reliability indicated by the first reliability information and the reliability indicated by the second reliability information are high, the color graphic 531 indicating that the reliability is high is determined as the reliability information 530.

After the generation of the reliability information 530, the processing unit 110 of the AI server 101 generates the consideration information 540 representing the consideration for the determination of the recommended value 410 based on the color material value information 160 and the test chart image 140 (S316 in FIG. 11), and the prediction processing of the maximum ink amount Qm ends. The consideration information 540 may be character information representing the reliability of the recommended patch 520, explanatory information derived from the process of inference according to the trained model 300, or the like. For example, the processing unit 110 may generate character information representing the reliability of the recommended value corresponding to the recommended patch 520 as the consideration information 540 based on the reliability information 530 generated based on the color material value information 160 and the test chart image 140. In addition, the processing unit 110 may construct the trained model 300 as in the machine learning model disclosed in JP-A-2022-138761, and acquire explanatory information derived from the process of determining the predicted value PV1 according to the trained model 300 for the recommended patch 520 from the trained model 300 as the consideration information 540. Obviously, the processing unit 110 may generate the consideration information 540 including the above-described character information and the above-described explanatory information.

After the prediction processing of the maximum ink amount Qm, the processing unit 110 of the AI server 101 generates display data for displaying the overall image display part 501 as shown in FIG. 8 (S206 in FIG. 10). For example, the processing unit 110 includes, in the overall image of the test chart CH2, the appropriate range information 515 for making the plurality of appropriate range patches 511 in the appropriate range among the plurality of test patches PA2 to stand out more than the plurality of remaining inappropriate range patches 512 as the prediction information 400. The processing unit 110 includes the recommended patch 520 indicating the recommended value 410 of the maximum ink amount Qm in the overall image display part 501.

Next, the processing unit 110 of the AI server 101 generates display data for displaying the recommended portion display part 502 as shown in FIG. 8 (S208). For example, the processing unit 110 sets the recommended patch 520 of each pattern array P0 to be equal to or larger than the size of each test patch PA2 (see FIG. 3) in the test chart CH2, and adds the reliability information 530 indicating the reliability of the recommended value 410 corresponding to each recommended patch 520. In addition, the processing unit 110 adds the warning information 550 indicating that the reliability information 530 is smaller than a predetermined reference on the recommended patch 520 having low reliability of the recommended value 410. In the example shown in FIG. 12, the processing unit 110 adds the warning information 550 to the recommended patch 520 corresponding to σ²>TS2. In the example shown in FIG. 13, the processing unit 110 adds the warning information 550 to the recommended patch 520 corresponding to FS5<TR1.

Next, the processing unit 110 of the AI server 101 adds the above-described consideration information 540 to the report information 500 including the overall image display part 501 and the recommended portion display part 502 to which the warning information 550 is added as necessary (S210). The processing unit 110 of the AI server 101 performs processing for transferring the generated report information 500 to the print server 102.

Finally, the processing unit 110 of the AI server 101 controls the communication I/F 117 to transmit the overall image display part 501, the recommended portion display part 502 to which the warning information 550 is added as necessary, and the report information 500 including the consideration information 540 to the printer 200 via the network NE1 (S212). Accordingly, the report information 500 is transmitted from the print server 102 to the printer 200. Upon receiving the report information 500 from the print server 102, the printer 200 prints the report information 500 as shown in FIG. 8 on the printing medium ME0.

When viewing the report information 500 on the printing medium ME0, the user US1 can check the plurality of appropriate range patches 511 in the appropriate range of the maximum ink amount Qm from the overall image of the test chart CH2 in the overall image display part 501. In addition, in the overall image display part 501, the position of the recommended patch 520 included in the plurality of appropriate range patches 511 can also be checked for each pattern array P0. In the recommended portion display part 502, the user US1 can check the recommended patch 520 corresponding to the recommended value 410 of the maximum ink amount Qm with a size equal to or larger than the size of each test patch PA2 in the test chart CH2 (see FIG. 3). Here, the reliability information 530 indicating the reliability of the recommended value 410 is added to the recommended patch 520, the warning information 550 is added to the recommended patch 520 having low reliability, and the consideration information 540 for determining the recommended value 410 also exists in the report information 500. Therefore, the user US1 can select the recommended patch 520 or the test patch PA2 other than the recommended patch 520 with reference to the reliability information 530 or the like. For example, the user US1 can select the recommended patch 520 when the reliability of the recommended value 410 is high, and can select the appropriate range patch 511 other than the recommended patch 520 when the reliability of the recommended value 410 is low.

As described above, the user US1 who uses the print system 1 in the present specific example can obtain the report information 500 in which the test patch PA2 can be selected in consideration of a desire of the user via the network NE1.

The maximum ink amount Qm may be set mainly by the AI server 101, or may be set mainly by the print server 102, the terminal 180, or the printer 200. Here, the subject that sets the maximum ink amount Qm is referred to as a processing subject. The processing subject receives an input for selecting any of the plurality of test patches PA2 included in the test chart CH2, and sets the ink amount Q1 per unit area corresponding to the selected test patch PA2 to the maximum ink amount Qm. For example, in the test chart CH2 shown in FIG. 3, when the test patch PA2 of Q1=85% in the pattern array P11 of “C/M” is selected, the processing subject sets the maximum ink amount Qm of C to 85%. In this case, a maximum ink amount Qm different from the recommended value 80% indicated by the recommended patch 520 shown in FIG. 8 is set. Obviously, when the recommended patch 520 in the pattern array P11 of “C/M” is selected, the processing unit 110 sets the maximum ink amount Qm of C to the recommended value 80%.

The maximum ink amount Qm is not limited to being set for each pattern array P0, and the primary colors may be collectively set, or the secondary colors may be collectively set. In this case, when the test patch PA2 of Q1=80% in any of the pattern arrays of the primary color is selected, the processing unit 110 sets the maximum ink amount Qm of the primary color to 80%. When the maximum ink amount Qm in which the primary colors are collected is set, the trained model 300 for the primary colors may be generated by machine learning based on the data set DS1 in which the primary colors are collected. When the maximum ink amount Qm in which the secondary colors are collected is set, the trained model 300 for the secondary colors may be generated by machine learning based on the data set DS1 in which the secondary colors are collected.

The determined maximum ink amount Qm is used for creating the color conversion LUT 600 (see FIG. 14) to be referred to in the color conversion processing. As shown in FIG. 14, it is assumed that the coordinate values (C, M, Y, K)=(Ci, Mi, Yi, Ki) of the ink amount data are associated with the grid point GD1 in which the coordinate values (R, G, B) of the RGB data are (Ri, Gi, Bi). In this case, the processing unit 110 generates the color conversion LUT 600 such that an ink amount obtained by combining an ink amount corresponding to a coordinate value Ci, an ink amount corresponding to a coordinate value Mi, an ink amount corresponding to a coordinate value Yi, and an ink amount corresponding to a coordinate value Ki is equal to or less than the maximum ink amount Qm. When the color conversion processing is performed according to the color conversion LUT 600 generated in this manner, the ink amount per unit area in the print image IM0 is limited to the maximum ink amount Qm or less.

Obviously, the color conversion LUT is not limited to the color conversion LUT 600 described above. Input coordinate values of the color conversion LUT may be coordinate values of C, M, and Y, coordinate values of C, M, Y, and K, or the like. Output coordinate values of the color conversion LUT may be coordinate values of C, M, Y, K, and special colors. Examples of the special color include Or (orange), Gr (green), Lc (light cyan) lower in density than C, Lm (light magenta) lower in density than M, Dy (dark yellow) higher in density than Y, and Lk (light black) lower in density than K. Further, the processing unit 110 may generate the print data after converting the RGB data or the like into the ink amount data according to the color conversion LUT having a possibility of exceeding the maximum ink amount Qm and converting the ink amount of each pixel of the ink amount data into the maximum ink amount Qm or less.

### 5. Modifications

Various Variations of the Present Disclosure Are conceivable.

For example, the printer 200 may be coupled to the terminal 180 without being coupled to the network NE1. In this case, the server 100 may transmit the report information 500 to the terminal 180 via the network NE1 with the terminal 180 as a transmission target device. When the terminal 180 causes the printer 200 to print the report information 500, the user can select the test patch PA2 in consideration of a desire of the user with reference to the report information 500. The terminal 180 may display the report information 500 by itself. Even in this case, the user can select the test patch PA2 in consideration of a desire of the user with reference to the report information 500. Obviously, even when the printer 200 is coupled to the network NE1, the server 100 may transmit the report information 500 to the terminal 180 via the network NE1. The server 100 may receive the color material value information 160 and the test chart image 140 from the printer 200 via the network NE1 with the printer 200 as a reception target device.

The processes described above can be changed as appropriate, for example, the order of the processes may be changed. For example, in the report output processing shown in FIG. 10, the processing of S206 and the processing of S208 can be switched.

Even when the consideration information 540 is not included in the report information 500 or the warning information 550 is not included in the report information 500, the user can obtain the report information in which the patch can be selected in consideration of a desire of the user via the network.

Elements other than the label LA1 and the divided training image 122 may be added to the data set DS1 for machine learning. When the trained model generation device 2 generates the trained model 300 in which the primary colors or the secondary colors are collected, color information of the solid region PA3 and color information of the line region PA4 may be added to the data set DS1. In this case, the support device 3 can acquire the predicted value PV1 by executing the trained model 300 using the divided test image 142, the color information of the solid region PA3, and the color information of the line region PA4 as inputs, and can output the prediction information 400. When the trained model generation device 2 generates the trained model 300 in which a plurality of types of printing media ME0 are collected, type information of the printing medium ME0 may be added to the data set DS1. In this case, the support device 3 can acquire the predicted value PV1 by executing the trained model 300 using the divided test image 142 and the type information of the printing medium ME0 as inputs, and can output the prediction information 400. Further, an element such as an output resolution may be added to the data set DS1.

The patch PA0 including the trained patch PA1 and the test patch PA2 may be a solid patch in which the line region PA4 does not exist, the type of the ink 236 does not change, and the ink amount Q1 per unit area is uniform. Even in this case, since phenomena such as “bleeding” of ink, “aggregation” of ink, and “overflow” of ink may occur, the predicted value PV1 can be acquired using the trained model 300, and the prediction information 400 can be output.

In the processing described above, for example, the determination of whether the value “exceeds” can be replaced with the determination of whether the value is “equal to or greater than”, and the determination of whether the value is “equal to or less than” can be replaced with the determination of whether the value is “smaller than”. Obviously, the determination of whether the value is “smaller than” can be replaced with the determination of whether the value is “equal to or less than”, and the determination of whether the value is “equal to or greater than” can be replaced with the determination of whether the value is “greater than”. Replacement of the determination as described above is also included in the aspect of the present application.

### 6. Conclusion

As described above, according to various aspects of the present disclosure, it is possible to provide a configuration and the like capable of obtaining, via a network, report information in which a user can select a patch in consideration of a desire of the user. The basic effects and advantages described above can, of course, also be achieved by aspects having only configuration requirements according to the independent claims.

In addition, it is conceivable to employ a configuration in which the elements disclosed in the examples described above are interchanged with each other or the combination of the elements is changed, a configuration in which the elements disclosed in known technologies and the examples described above are interchanged with each other or the combination of the elements is changed, and the like. The present disclosure also includes the configurations described above and the like.

What is claimed is:

1. A server for communicating, via a network, information for a printer configured to print a chart including a plurality of patches, the server comprising:
a communication unit configured to receive, from a reception target device via the network, color material value information indicating a color material value of each of the patches and a chart image obtained by reading the chart, and to transmit report information related to the printer to a transmission target device via the network; and
a processing unit configured to generate the report information including an overall image display part indicating an overall image of the chart including the plurality of patches, and a recommended portion display part indicating a recommended patch corresponding to a recommended value of the color material value among the plurality of patches, wherein
the processing unit
determines, based on the color material value information and the chart image, an appropriate range of the color material value and the recommended value of each of the patches, and generates reliability information indicating reliability of the recommended value,
includes, in the overall image display part, appropriate range information that distinguishes a plurality of appropriate range patches among the plurality of patches that are within the appropriate range from a remaining plurality of inappropriate range patches in an overall image of the chart, and
adds, in the recommended portion display part, the reliability information to the recommended patch.

2. The server according to claim 1, wherein
the chart includes the plurality of patches having different ink amounts per unit area on a printing medium,
the color material value of each of the patches corresponds to the ink amount per unit area of the patch,
the appropriate range and the recommended value are applied to a maximum ink amount that is an upper limit of the ink amount per unit area, and
the processing unit determines the appropriate range and the recommended value for the maximum ink amount based on the color material value information and the chart image.

3. The server according to claim 1, wherein
the processing unit generates consideration information representing consideration for determination of the recommended value based on the color material value information and the chart image, and generates the report information further including the consideration information.

4. The server according to claim 1, wherein
the reception target device is a terminal,
the transmission target device is the printer, and
the processing unit generates the report information to be printed by the printer.

5. The server according to claim 1, wherein
the report information is information for causing the printer to print, and
the processing unit generates the report information such that the recommended patch is equal to or greater than a size of the patch in the chart.

6. The server according to claim 1, wherein
the processing unit includes, in the overall image display part, the appropriate range information in which the plurality of inappropriate range patches are thinned or hidden in the overall image of the chart.

7. The server according to claim 1, wherein
when the reliability information is lower than a predetermined reference, the processing unit controls the communication unit to transmit warning information indicating that the reliability information is lower than the reference to the transmission target device.

8. A report output method in which information for a printer configured to print a chart including a plurality of patches is output by a server configured to communicate via a network, the method comprising:
a reception step of receiving, from a reception target device via the network, color material value information indicating a color material value of each of the patches and a chart image obtained by reading the chart;
a prediction step of determining, based on the color material value information and the chart image, an appropriate range and a recommended value of the color material value of each of the patches, and generating reliability information indicating reliability of the recommended value;
an overall image processing step of including, in an overall image display part included in report information related to the printer, appropriate range information that distinguishes a plurality of appropriate range patches among the plurality of patches that are within the appropriate range from a remaining plurality of inappropriate range patches in an overall image of the chart including the plurality of patches;
a recommended portion processing step of adding, in a recommended portion display part included in the report information, the reliability information to a recommended patch corresponding to the recommended value among the plurality of patches; and
a transmission step of transmitting the report information including the overall image display part and the recommended portion display part to a transmission target device via the network.

9. A report output system comprising:
a server configured to communicate, via a network, information for a printer configured to print a chart including a plurality of patches; and
a transmission target device coupled to the network, wherein
the server includes
a communication unit configured to receive, from a reception target device via the network, color material value information indicating a color material value of each of the patches and a chart image obtained by reading the chart, and to transmit report information related to the printer to a transmission target device via the network, and
a processing unit configured to generate the report information including an overall image display part indicating an overall image of the chart including the plurality of patches, and a recommended portion display part indicating a recommended patch corresponding to a recommended value of the color material value among the plurality of patches,
the processing unit
determines, based on the color material value information and the chart image, an appropriate range of the color material value and the recommended value of each of the patches, and generates reliability information indicating reliability of the recommended value,
includes, in the overall image display part, appropriate range information that distinguishes a plurality of appropriate range patches among the plurality of patches that are within the appropriate range from a remaining plurality of inappropriate range patches in an overall image of the chart, and
adds, in the recommended portion display part, the reliability information to the recommended patch, and
the transmission target device receives the report information from the server via the network and prints or displays the received report information.
